(19) United States
(12) Patent Application Publication
(10) Pub. No.: US 2022/0316260 A1
(43) Pub. Date: Oct. 6, 2022

(54) Trunk Control Method and Apparatus, and Storage Medium

(71) Applicant: Shanghai SenseTime Lingang Intelligent Technology Co., Ltd., Shanghai (CN)

(72) Inventors: Ying Tao, Shanghai (CN); Ke Li, Shanghai (CN); Liang Xu, Shanghai (CN); Jun Wu, Shanghai (CN); Yiqing Fan, Shanghai (CN); Kaiyue Qi, Shanghai (CN)

(73) Assignee: Shanghai SenseTime Lingang Intelligent Technology Co., Ltd., Shanghai (CN)

(21) Appl. No.: 17/841,831

(22) Filed: Jun. 16, 2022

Related U.S. Application Data
(63) Continuation of application No. PCT/CN2021/078704, filed on Mar. 2, 2021.

(30) Foreign Application Priority Data
Sep. 15, 2020 (CN) 202010970973.3

(51) Int. Cl. E05F 15/73; E05F 15/40

(52) U.S. Cl. CPC E05F 15/73; E05F 15/40; B60R 11/04

(57) ABSTRACT

The present disclosure relates to a trunk control method and apparatus, a vehicle, an electronic device, and a storage medium. The method includes acquiring sensing data of a rear area of a vehicle; detecting a target object in the rear area of the vehicle according to the sensing data; and controlling a trunk of the vehicle to close in response to the trunk being in an open state and not detecting the target object.

### CROSS-REFERENCE TO RELATED APPLICATION

This application is a continuation of and claims priority under 35 U.S.C. § 120 to PCT Application. No. PCT/CN2021/078704, filed on Mar. 2, 2021, which is based upon and claims priority of Chinese Patent Application entitled “Trunk Control Method and Apparatus, Vehicle, Electronic Device, and Storage Medium” filed on Sep. 15, 2020, with the Application No. 202010970973.3. All the above referenced priority documents are hereby incorporated by reference.

### TECHNICAL FIELD

The present disclosure relates to the technical field of vehicles, and particularly to a trunk control method and apparatus, a vehicle, an electronic device, and a storage medium.

### BACKGROUND

Vehicle is one of the main transportation means for people to travel. The trunk of a vehicle is often used as an important storage space of the vehicle. In the related art, a trunk that has been opened is usually closed by a remote control key or closed manually is not convenient.

### SUMMARY

The present disclosure provides a technical solution for the control of a trunk.

According to one aspect of the disclosure, a trunk control method is provided, comprising:

acquiring sensing data of a rear area of a vehicle;
detecting a target object in the rear area of the vehicle according to the sensing data; and
controlling a trunk of the vehicle to close in response to the trunk being in an open state and not detecting the target object.

In a possible implementation,

detecting the target object in the rear area of the vehicle according to the sensing data comprises: detecting the target object within a preset distance range from a rear portion of the vehicle to an exterior of a vehicle cabin according to the sensing data; and
controlling the trunk of the vehicle to close in response to the trunk being in the open state and not detecting the target object comprises: controlling the trunk to close in response to the trunk being in the open state and not detecting the target object within the preset distance range from the rear portion of the vehicle to the exterior of the vehicle cabin.

In a possible implementation, controlling the trunk of the vehicle to close in response to the trunk being in the open state and not detecting the target object comprises:

controlling the trunk to close in response to the trunk being in the open state and not detecting the target object within a first preset time length.

In a possible implementation, the target object comprises a human body object;

detecting the target object in the rear area of the vehicle according to the sensing data comprises:
detecting information of at least one human body part in the rear area of the vehicle according to the sensing data; and
determining that a human body object in the rear area of the vehicle is detected in response to the information of at least one human body part is detected in the rear area of the vehicle;
and/or determining that the human body object in the rear area of the vehicle is not detected in response to the information of at least one human body part is not detected in the rear area of the vehicle.

In a possible implementation, acquiring the sensing data of the rear area of the vehicle comprises: acquiring first image data of the rear area of the vehicle collected by a reversing camera; and

detecting the information of at least one human body part in the rear area of the vehicle according to the sensing data comprises: detecting the information of at least one human body part in the rear area of the vehicle according to the first image data.

In a possible implementation, detecting the information of at least one human body part in the rear area of the vehicle according to the sensing data comprises:

detecting foot information and/or leg information in the rear area of the vehicle according to the first image data in a case where the reversing camera faces the ground;
and/or,
detecting human body information and/or face information in the rear area of the vehicle according to the first image data in a case where the reversing camera faces a direction away from the ground.

In a possible implementation,

acquiring the sensing data of the rear area of the vehicle comprises: acquiring second image data of the rear area of the vehicle collected by a first camera, wherein the first camera is installed on an inner side surface of a trunk door; and
detecting the information of at least one human body part in the rear area of the vehicle according to the sensing data comprises: detecting the information of at least one human body part in the rear area of the vehicle according to the second image data.

In a possible implementation, the first camera is installed in a position of a high-mounted brake light on the trunk door.

In a possible implementation, he method further comprises: controlling the first camera to collect the second image data of the rear area of the vehicle in response to the trunk being opened.

In a possible implementation, the sensing data comprises radar sensing data;

detecting the information of at least one human body part in the rear area of the vehicle according to the sensing data comprises:
performing obstacle detection on the rear area of the vehicle according to the radar sensing data; and
determining that the information of at least one human body part in the rear area of the vehicle is detected in response to detecting presence of an obstacle in the rear area of the vehicle according to the radar sensing data; and/or determining that the information of at least one human body part in the rear area of the vehicle is not detected in response to not detecting presence of an obstacle in the rear area of the vehicle according to the radar sensing data.

In a possible implementation, acquiring the sensing data of the rear area of the vehicle comprises:

acquiring radar sensing data of the rear area of the vehicle collected by a reversing radar.

In a possible implementation,

acquiring the sensing data of the rear area of the vehicle comprises: acquiring third image data of the rear area of the vehicle collected by an Occupant Monitoring System (OMS) camera; and
detecting the target object in the rear area of the vehicle according to the sensing data comprises: detecting human body information and/or face information in the rear area of the vehicle according to the third image data; and determining that the target object is detected in response to the human body information or the face information is detected in the rear area of the vehicle.

In a possible implementation, the OMS camera is installed on an inner rear-view mirror of the vehicle and faces a rear direction of the vehicle.

In a possible implementation, acquiring the sensing data of the rear area of the vehicle comprises:

acquiring the sensing data of the rear area of the vehicle in response to a duration of the trunk being in the open state reaching a second preset time length.

In a possible implementation, the method further comprises: controlling the trunk to open in response to detecting the target object in the rear area of the vehicle according to the sensing data during a process of closing the trunk.

In a possible implementation, the method further comprises: acquiring image data of a driving area of the vehicle collected by a Driver Monitoring System (DMS) camera;

detecting whether a driver is seated in the driving area according to the image data of the driving area;
sending inquiry information for asking whether to close the trunk in response to detecting that the driver is seated in the driving area and the trunk is in the open state; and
controlling the trunk to close in response to receiving a closing request corresponding to the inquiry information.

In a possible implementation, the method further comprises:

determining a personnel object requesting opening the trunk as a target object in response to detecting that the trunk is changed from a closed state to the open state; and
detecting the target object in the rear area of the vehicle according to the sensing data comprises:
detecting whether the personnel object in the rear area of the vehicle comprises the target object according to the sensing data.

In a possible implementation, the method further comprises:

controlling the trunk to open in response to the trunk being in the closed state and detecting that a preset personnel object requests opening the trunk according to the sensing data of the rear area of the vehicle.

According to one aspect of the disclosure, a trunk control apparatus is provided, comprising:

a first acquiring module configured to acquire sensing data of a rear area of a vehicle;
a first detecting module configured to detect a target object in the rear area of the vehicle according to the sensing data; and
a first controlling module configured to control a trunk to close in response to the trunk of the vehicle being in an open state and not detecting the target object.

In a possible implementation,

the first detecting module is configured to detect a target object within a preset distance range from a rear portion of the vehicle to the exterior of a vehicle cabin according to the sensing data;
the first controlling module is configured to control the trunk to close in response to the trunk being in an open state and not detecting the target object within the preset distance range from the rear portion of the vehicle to the exterior of the vehicle cabin.

In a possible implementation, the first controlling module is configured to:

control the trunk to close in response to the trunk being in an open state and not detecting the target object within a first preset time length.

In a possible implementation, the target object includes a human body object;

the first detecting module is configured to:
detect information of at least one human body part in the rear area of the vehicle according to the sensing data; and
determine that a human body object in the rear area of the vehicle is detected in response to the information of at least one human body part is detected in the rear area of the vehicle; and/or
determine that the human body object in the rear area of the vehicle is not detected in response to the information of at least one human body part is not detected in the rear area of the vehicle.

In a possible implementation,

the first acquiring module is configured to acquire first image data of the rear area of the vehicle collected by a reversing camera; and
the first detecting module is configured to detect information of at least one human body part in the rear area of the vehicle according to the first image data.

In a possible implementation, the first detecting module is configured to:

detect foot information and/or leg information in the rear area of the vehicle according to the first image data in a case where the reversing camera faces the ground;
and/or,
detect human body information and/or face information in the rear area of the vehicle according to the first image data in a case where the reversing camera faces a direction away from the ground.

In a possible implementation,

the first acquiring module is configured to acquire second image data of the rear area of the vehicle collected by a first camera, wherein the first camera is installed on an inner side surface of a trunk door; and
the first detecting module is configured to detect the information of at least one human body part in the rear area of the vehicle according to the second image data.

In a possible implementation, the first camera is installed in a position of a high-mounted brake light on the trunk door.

In a possible implementation, the apparatus further includes:

a second controlling module configured to control the first camera to collect the second image data of the rear area of the vehicle in response to the trunk being opened.

In a possible implementation, the sensing data includes radar sensing data; the first detecting module is configured to:

perform obstacle detection on the rear area of the vehicle according to the radar sensing data; and
determine that the information of at least one human body part in the rear area of the vehicle is detected in response to detecting presence of an obstacle in the rear area of the vehicle according to the radar sensing data; and/or determine that the information of at least one human body part in the rear area of the vehicle is not detected in response to not detecting presence of an obstacle in the rear area of the vehicle according to the radar sensing data.

In a possible implementation, the first acquiring module is configured to: acquire radar sensing data of the rear area of the vehicle collected by a reversing radar.

In a possible implementation,

the first acquiring module is configured to acquire third image data of the rear area of the vehicle collected by an Occupant Monitoring System (OMS) camera; and
the first detecting module is configured to detect human body information and/or face information in the rear area of the vehicle according to the third image data; and determine that the target object is detected in response to the human body information or face information is detected in the rear area of the vehicle.

In a possible implementation, the OMS camera is installed on an inner rear-view mirror of the vehicle and faces a rear direction of the vehicle.

In a possible implementation, the first acquiring module is configured to acquire the sensing data of the rear area of the vehicle in response to a duration of the trunk being in the open state reaching a second preset time length.

In a possible implementation, the apparatus further includes:

a fifth controlling module configured to control the trunk to open in response to detecting a target object in the rear area of the vehicle according to the sensing data during a process of closing the trunk.

In a possible implementation, the apparatus further includes:

a second acquiring module configured to acquire image data of a driving area of the vehicle collected by a Driver Monitoring System (DMS) camera;
a second detecting module configured to detect whether a driver is seated in the driving area according to the image data of the driving area;
a sending module configured to send inquiry information for asking whether to close the trunk in response to detecting that the driver is seated in the driving area and the trunk is in the open state; and
a third controlling module configured to control the trunk to close in response to receiving a closing request corresponding to the inquiry information.

In a possible implementation,

the apparatus further includes: a determining module configured to determine a personnel object requesting opening the trunk as a target object in response to detecting that the trunk is changed from a closed state to an open state; and
the first detecting module is configured to detect whether personnel objects in the rear area of the vehicle include the target object according to the sensing data.

In a possible implementation, the apparatus further includes: a fourth controlling module configured to control the trunk to open in response to the trunk being in the closed state and detecting that the preset personnel object requests opening the trunk according to the sensing data of the rear area of the vehicle.

In an embodiment of the present disclosure, by acquiring sensing data of the rear area of the vehicle, detecting a target object in the rear area of the vehicle according to the sensing data, and controlling a trunk of the vehicle to close in response to the trunk being in an open state and not detecting the target object, it is possible to realize automated closing of the trunk based on the sensing data of the rear area of the vehicle and non-contact closing of the trunk;

that is, the trunk close automatically without the user touching the trunk door, thereby improving the convenience for closing the trunk. Especially in a case where both hands of the user are occupied (e.g., holding a luggage, an umbrella, and the like), an embodiment of the present disclosure realizing automated closing of the trunk door makes it very convenient for the user. Furthermore, by controlling a trunk of the vehicle to close in response to the trunk being in an open state and not detecting the target object, it is possible to greatly reduce the possibility of the user being injured due to being pinched by the trunk door, improving the safety in trunk control. Moreover, by automated closing of the trunk door according to the embodiment of the present disclosure is also conducive to strengthening property safety of the vehicle cabin (including the trunk).

It should be understood that the above general descriptions and the following detailed descriptions are only exemplary and illustrative, and do not limit the present disclosure.

Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 is a flow chart of a trunk control method provided in an embodiment of the present disclosure.

FIG. 2 is a schematic diagram of a position of a sensor in an embodiment of the present disclosure.

FIG. 3 is a block diagram of a trunk control apparatus provided in an embodiment of the present disclosure.

FIG. 4 is a block diagram of an electronic device provided in an embodiment of the present disclosure.

FIG. 5 is a block diagram of an electronic device provided in an embodiment of the present disclosure.

### DETAILED DESCRIPTION

Various exemplary embodiments, features and aspects of the present disclosure are described in detail below with reference to the accompanying drawings. Reference numerals in the drawings refer to elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

Terms “and/or” used herein is only an association relationship describing the associated objects, which means that there may be three relationships, for example, A and/or B may mean three situations: A exists alone, both A and B exist, and B exists alone. Furthermore, the item “at least one of” herein means any one of a plurality of or any combinations of at least two of a plurality of, for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

FIG. 1 is a schematic flow chart of a trunk control method provided in an embodiment of the present disclosure. An entity executing the trunk control method may be a trunk control apparatus. In a possible implementation, the trunk control method may be executed by a terminal device, a server or other processing devices. The terminal device may be a vehicle-mounted device, user equipment (UE), a mobile device, a user terminal, a terminal, a cellular phone, a cordless telephone, a personal digital assistant (PDA), a handheld device, a computing device, or a wearable device, etc. The vehicle-mounted device may be a controller, a domain controller or a vehicle machine in a vehicle cabin, or may be a device host for processing images and other data in an Occupant Monitoring System (OMS) or a Driver Monitoring System (DMS). In some possible implementations, the trunk control method may be implemented by a processor calling computer readable instructions stored in a memory. As shown in FIG. 1, the trunk control method includes steps S11-S13.

In the step S11, sensing data of a rear area of a vehicle is acquired.

The vehicle in an embodiment of the present disclosure may be at least one of a private car, a shared car, an online-hailed car, a taxi, and the like.

In an embodiment of the present disclosure, the sensing data of the rear area of the vehicle may be collected by a sensor; and the sensing data of the rear area of the vehicle may be acquired from the sensor. The sensor may be a sensor for sensing information of the vehicle and is usually attachable to the vehicle. One or more of the sensor may be provided. The sensor may include at least one of a camera, a radar, a distance sensor, and the like. The camera may include one or more cameras installed outside and/or inside the vehicle. For example, the camera may include a camera installed at the rear portion of the vehicle. For example, the camera installed at the rear portion of the vehicle may include a reversing camera installed at the rear portion of the vehicle, and may also include other cameras installed at the rear portion of the vehicle. For another example, the camera may also include a camera installed on an inner side surface of the trunk. For another example, the camera may also include an OMS camera and/or a DMS camera, etc. The radar may be used for measuring a distance between the radar and an obstacle in front of the radar. The radar may include a reversing radar installed at the rear portion of the vehicle, and may also include other radars installed at the rear portion of the vehicle. The distance sensor may be used for measuring a distance between the distance sensor and an obstacle in front of the distance sensor. The distance sensor may include at least one of an ultrasonic distance sensor, an infrared distance sensor, and the like.

In an embodiment of the present disclosure, the sensing data of the rear area of the vehicle may include at least one of image data, radar sensing data, distance sensing data, and the like of the rear area of the vehicle. The image data of the rear area of the vehicle may include image data and/or video data of the rear area of the vehicle. The above sensing data may be acquired through a connection established with the sensor for sensing the information of the rear area of the vehicle.

In the step S12, a target object in the rear area of the vehicle is detected according to the sensing data.

In an embodiment of the present disclosure, the target object may refer to a detected object. The target object may include an object of a preset type and/or an object of a non-preset type. The object of a preset type may include at least one of a human body object, an animal body object, and the like. The object of a non-preset type may refer to an obstacle of any type.

In a possible implementation, a target object within a preset distance range from the rear portion of the vehicle to the exterior of the vehicle may be detected according to at least one of the radar sensing data, the distance sensing data and the image data of the rear area of the vehicle. In another possible implementation, a target object within a preset size range outside the rear portion of the vehicle may be detected according to the image data of the rear area of the vehicle. In an embodiment of the present disclosure, by detecting a target object in the rear area of the vehicle according to the sensing data, a detection result of “detecting a target object in the rear area of the vehicle” or a detection result of “not detecting a target object in the rear area of the vehicle” is obtained. Detecting a target object in the rear area of the vehicle may indicate that a target object is detected in the rear area of the vehicle; not detecting a target object in the rear area of the vehicle may indicate that no target object is detected in the rear area of the vehicle.

In an embodiment of the present disclosure, the detection result of the target object may be determined by matching a feature of the detected target object with a feature extracted from the sensing data of the rear area of the vehicle. The feature of the target object may be a shape, a size, a color, a texture, and the like, and/or a feature obtained by performing feature extraction on two-dimensional data or three-dimensional data of the target object using a feature extracting model.

In the step S13, the trunk is controlled to be closed in response to the trunk of the vehicle being in an open state and not detecting the target object.

For example, a trunk closing instruction may be generated in response to the trunk being in an open state and not detecting the target object, which is then sent to a vehicle body controlling module so that the trunk is controlled to be closed by the vehicle body controlling module according to the trunk closing instruction. For another example, the trunk closing instruction may be generated in response to the trunk being in an open state and not detecting the target object and sent to a trunk controlling circuit so that the trunk is controlled to be closed by the trunk controlling circuit according to the trunk closing instruction.

In some possible implementations of the embodiment of the present disclosure, in a case where the trunk of the vehicle is in the open state and the target object is detected, the trunk may be kept in the open state.

In an embodiment of the present disclosure, by acquiring sensing data of the rear area of the vehicle, detecting a target object in the rear area of the vehicle according to the sensing data, and controlling a trunk of the vehicle to close in response to the trunk being in an open state and not detecting the target object, it is possible to realize automated closing of the trunk based on the sensing data of the rear area of the vehicle and non-contact closing of the trunk; that is, the trunk closes automatically without the user touching the trunk door, thereby improving the convenience for closing the trunk. Especially in a case where both hands of the user are occupied (e.g., holding a luggage, an umbrella, and the like), an embodiment of the present disclosure realizing automated closing of the trunk makes it very convenient for the user. Furthermore, by controlling a trunk of the vehicle to close in response to the trunk being in an open state and not detecting the target object, it is possible to greatly reduce the possibility of the user being injured due to being pinched by the trunk door, improving the safety in trunk control. Moreover, by automated closing of the trunk according to the embodiment of the present disclosure is also conducive to strengthening property safety of the vehicle cabin (including the trunk).

In a possible implementation, detecting a target object in the rear area of the vehicle according to the sensing data includes: detecting a target object within a preset distance range from a rear portion of the vehicle to an exterior of a vehicle cabin according to the sensing data; and controlling a trunk of the vehicle to close in response to the trunk being in an open state and not detecting the target object includes: controlling the trunk to close in response to the trunk being in an open state and not detecting the target object within the preset distance range from the rear portion of the vehicle to the exterior of the vehicle cabin. In this implementation, the preset distance range may be 0-80 cm. Of course, those skilled in the art may set the preset distance range flexibly according to the requirements of the actual application scenario, which is not limited herein. In this implementation, by detecting the target object within the preset distance range from the rear portion of the vehicle to the exterior of the vehicle cabin, it is possible to reduce the interference of a target object beyond the preset distance range with the trunk control, and reduce the possibility of wrong control of the trunk.

As an example of the implementation, the sensing data may include radar sensing data collected by a radar installed at the rear portion of the vehicle; and detecting a target object within a preset distance range from a rear portion of the vehicle to an exterior of a vehicle cabin according to the sensing data may include: detecting a target object for which a distance from the radar within the preset distance range according to the radar sensing data; determining that the target object is detected within the preset distance range from the rear portion of the vehicle to the exterior of the vehicle cabin in response to detecting a target object for which a distance from the radar within the preset distance range; and determining that the target object is not detected within the preset distance range from the rear portion of the vehicle to the exterior of the vehicle cabin in response to not detecting a target object for which a distance from the radar within the preset distance range.

The radar installed at the rear portion of the vehicle may be a reversing radar, so that an automatic control function of the trunk may be realized with the aid of the reversing radar.

As another example of the implementation, the sensing data may include distance sensing data collected by a distance sensor installed at the rear portion of the vehicle; and detecting a target object within a preset distance range from a rear portion of the vehicle to an exterior of a vehicle cabin according to the sensing data may include: detecting a target object for which a distance from the distance sensor within the preset distance range according to the distance sensing data; determining that the target object is detected within the preset distance range from the rear portion of the vehicle to the exterior of the vehicle cabin in response to detecting a target object for which a distance from the distance sensor within the preset distance range; and determining that the target object is not detected within the preset distance range from the rear portion of the vehicle to the exterior the vehicle cabin in response to not detecting a target object for which a distance from the distance sensor within the preset distance range. The preset distance range from the rear portion of the vehicle to the exterior of the vehicle cabin may be a preset distance range from a trunk cover of the vehicle to the rear portion of the vehicle; and the preset distance range may be, for example, 0-80 cm. Of course, those skilled in the art may set the preset distance range flexibly according to the requirements of the actual application scenario, which is not limited herein. In this case, the obstacle in the rear area of the vehicle may be sensed accurately through the sensing data collected by the radar or the distance sensor installed at the rear portion of the vehicle, thereby acquiring a more accurate detection result of the target object.

In a possible implementation, controlling a trunk of the vehicle to close in response to the trunk being in an open state and not detecting the target object includes: controlling the trunk to close in response to the trunk being in an open state and not detecting the target object within a first preset time length. For example, the first preset time length may be 5 seconds. Of course, those skilled in the art may also set the first preset time length flexibly according to the requirements of the actual application scenario, which is not limited herein. In this implementation, not detecting the target object within the first preset time length may indicate that a duration of not detecting the target object reaches the first preset time length. In this implementation, if the duration of not detecting the target object does not reach the first preset time length, the trunk may be kept in the open state. By controlling a trunk of the vehicle to close in response to the trunk being in an open state and not detecting the target object within the first preset time length, it is possible to improve the efficiency and the accuracy of the trunk control, and reduce trunk control operation that is unnecessary or not required by the user. For example, after a driver in the vehicle cabin controls the trunk to be opened, it may take a short while for an occupant who needs to pick up articles from the trunk to reach the rear area of the vehicle. In this implementation, by setting the first preset time length, it is possible to effectively cope with the situation that the occupant has not arrived at the rear area of the vehicle or temporarily leaves the rear area of the vehicle.

In a possible implementation, the target object includes a human body object; detecting a target object in the rear area of the vehicle according to the sensing data includes: detecting information of at least one human body part in the rear area of the vehicle according to the sensing data; determining that a human body object in the rear area of the vehicle is detected in response to the information of at least one human body part is detected in the rear area of the vehicle; and/or determining that a human body object in the rear area of the vehicle is not detected in response to the information of at least one human body part is not detected in the rear area of the vehicle. In the present implementation, the information of at least one human body part in the rear area of the vehicle may be detected according to at least one of the image data, the radar sensing data, and the distance sensing data of the rear area of the vehicle, so as to determine whether a human body object is present in the rear area of the vehicle. For example, the at least one human body part may include at least one of a foot, a leg, a human body, a face, and the like. The human body here may refer to at least one part of the body, the arm and the hand of a person. According to this implementation, by controlling the trunk to close in response to the trunk of the vehicle being in the open state and not detecting a human body object, it is possible to reduce the possibility of the user being injured due to being pinched by the trunk door, improving the safety in trunk control.

As an example of the implementation, acquiring sensing data of a rear area of a vehicle includes: acquiring first image data of the rear area of the vehicle collected by a reversing camera; and detecting information of at least one human body part in the rear area of the vehicle according to the sensing data includes: detecting information of at least one human body part in the rear area of the vehicle according to the first image data. In the example, the reversing camera may be installed at the rear portion of the vehicle and face the exterior of the vehicle cabin, for example facing the rear portion of the vehicle. One or more of the reversing camera may be provided. The reversing camera may face the ground (e.g., facing downward diagonally), or face a direction away from the ground (e.g., facing upward diagonally), or may face a rear direction of the vehicle. The orientation of the reversing camera may also adjustable (e.g., a rotatable camera), which is not limited herein. In the example, the first image data indicates image data of the rear area of the vehicle collected by the reversing camera. In the example, by detecting information of at least one human body part in the rear area of the vehicle according to the image data of the rear area of the vehicle collected by the reversing camera, it is possible to perform target object detection on the rear area of the vehicle by a method based on computer vision, which improves the accuracy of target object detection, without requiring an additional sensor.

In an example, detecting information of at least one human body part in the rear area of the vehicle according to the sensing data includes: detecting foot information and/or leg information in the rear area of the vehicle according to the first image data in a case where the reversing camera faces the ground; and/or detecting human body information and/or face information in the rear area of the vehicle according to the first image data in a case where the reversing camera faces a direction away from the ground. In the example, the orientation of the reversing camera may be adjustable or nonadjustable. In a case where the orientation of the reversing camera is adjustable, the orientation of the reversing camera may be adjusted automatically or manually. In the example, by detecting information of different human body parts according to different orientation of the reversing camera, specifically by detecting foot information and/or leg information in the rear area of the vehicle according to the first image data in a case where the reversing camera faces the ground and/or detecting human body information and/or face information in the rear area of the vehicle according to the first image data in a case where the reversing camera faces a direction away from the ground, it is possible to accurately determine whether a human body object is present in the rear area of the vehicle.

In an example, the reversing camera is a camera with adjustable orientation, and the method further includes: controlling the reversing camera to rotate to face a direction away from the ground in response to detecting that the trunk is changed from a closed state to the open state; and/or controlling the reversing camera to rotate to face the ground in response to detecting that the trunk is changed from the open state to the closed state.

Usually when the trunk is in the open state, the vehicle is in a static state. At this time, the reversing camera may be controlled to face the personnel at the trunk, that is, the reversing camera is controlled to face away from the ground, so as to detect whether the personnel at the trunk leaves the rear portion of the vehicle based on an image collected by the reversing camera. When the trunk is in the closed state, the driver may start the vehicle. At this time, the reversing camera may be controlled to face the ground to sense the ground behind the vehicle, thereby helping the driver to know the condition of the ground behind the vehicle accurately, improving the safety. As such, by controlling the reversing camera to adjust the orientation thereof according to the open state and closed state of the trunk, it is possible to realize more vehicle control functions without adding additional hardware, thereby improving the automatic control capability of the vehicle.

As another example of the implementation, acquiring sensing data of a rear area of a vehicle includes: acquiring second image data of the rear area of the vehicle collected by a first camera, wherein the first camera is installed on an inner side surface of the trunk door; and detecting information of at least one human body part in the rear area of the vehicle according to the sensing data includes: detecting information of at least one human body part in the rear area of the vehicle according to the second image data. In the example, the second image data indicates image data of the rear area of the vehicle collected by the first camera. In the example, the first camera is installed on the inner side surface of the trunk door, so that in a case where the trunk door is open, the first camera faces the rear area of the vehicle. In the example, detecting information of at least one human body part in the rear area of the vehicle according to the image data of the rear area of the vehicle collected by the first camera installed on the inner side surface of the trunk door, it is possible to perform target object detection on the rear area of the vehicle by a method based on computer vision, thereby improving the accuracy of the target object detection.

In the example, the first camera may be installed on the inner side surface of the trunk door close to a roof. In an example, the first camera is installed in a position of a high-mounted brake light on the trunk door, so that the image data of the rear area of the vehicle can be collected from a good viewing angle after the trunk door is open. Moreover, a hole is reserved at the position of the high-mounted brake light, which is convenient for the arrangement of a connection wire of the first camera.

In an example, the method further includes: controlling the first camera to collect the second image data of the rear area of the vehicle in response to the trunk being opened. In the example, in a case where the trunk is in the closed state, the first camera may not need to collect the image data, thereby saving the power consumption of the whole vehicle. By controlling the first camera to collect the second image data of the rear area of the vehicle in response to the trunk being opened, it is possible to control the first camera to collect the image data of the rear area of the vehicle in time after the trunk is opened, so as to control the trunk in a timely manner according to the image data of the rear area of the vehicle collected by the first camera.

As another example of the implementation, the sensing data includes radar sensing data; detecting information of at least one human body part in the rear area of the vehicle according to the sensing data includes: performing obstacle detection on the rear area of the vehicle according to the radar sensing data; and determining that the information of at least one human body part in the rear area of the vehicle is detected in response to detecting presence of an obstacle in the rear area of the vehicle according to the radar sensing data; and/or determining that the information of at least one human body part in the rear area of the vehicle is not detected in response to not detecting presence of an obstacle in the rear area of the vehicle according to the radar sensing data. In the example, the sensing data includes radar sensing data collected by a radar. One or more of radar may be provided. The obstacle detection may be performed by feature extraction and matching. By detecting whether an obstacle is present in the rear area of the vehicle according to the radar sensing data of the rear area of the vehicle collected by the radar, a detection result of the information of at least one human body part in the rear area of the vehicle is determined, so that the accuracy of the target object detection on the rear area of the vehicle is improved.

In an example, acquiring sensing data of a rear area of a vehicle includes: acquiring radar sensing data of the rear area of the vehicle collected by a reversing radar. In the example, by performing target object detection on the rear area of the vehicle according to the radar sensing data of the rear area of the vehicle collected by the reversing radar, it is possible to perform the target object detection on the rear area of the vehicle by means of an existing radar of the vehicle, saving the need for an additional radar, thereby saving the cost.

In a possible implementation, acquiring sensing data of a rear area of a vehicle includes: acquiring third image data of the rear area of the vehicle collected by an Occupant Monitoring System (OMS) camera; and detecting a target object in the rear area of the vehicle according to the sensing data includes: detecting human body information and/or face information in the rear area of the vehicle according to the third image data; and determining that the target object is detected in response to the information of a human body or a face information is detected in the rear area of the vehicle. In this implementation, the third image data indicates image data of the rear area of the vehicle collected by the OMS camera. As an example of the implementation, it may be determined that the human body information and/or the face information in the rear area of the vehicle is detected in response to the information of a human body and/or a face with a size within a preset size range is detected according to the third image data; and/or it may be determined that the human body information and/or the face information of the rear area of the vehicle is not detected in response to the information of a human body and/or a face with a size within the preset size range is not detected according to the third image data. As another example of the implementation, it may be determined that the human body information and/or the face information in the rear area of the vehicle is detected in response to the formation of a human body and/or a face located in a preset image coordinate area and/or a preset space coordinate area is detected according to the third image data; and/or it may be determined that the human body information and/or the face information in the rear area of the vehicle is not detected in response to the information of a human body and/or a face information located in the preset image coordinate area and/or the preset space coordinate area is not detected according to the third image data. The preset size range and the preset image coordinate area may be calculated in advance according to a distance from the OMS camera to the rear portion of the vehicle and the average size information of human body or the average size information of face. In this implementation, by detecting human body information and/or face information in the rear area of the vehicle according to the image data collected by the OMS camera, it is possible to improve the accuracy of the target object detection, without providing an additional sensor.

As an example of the implementation, the OMS camera is installed on an inner rear-view mirror of the vehicle and faces a rear direction of the vehicle. In the example, by the OMS camera installed on an inner rear-view mirror of the vehicle and facing a rear direction of the vehicle, image data of the rear area of the vehicle is acquired, so that it is possible to accurately perform the target object detection according to the image data collected by the OMS camera. In another example, the OMS camera may be installed in any position of the vehicle as long as the OMS camera faces the rear direction of the vehicle and is capable of acquiring the image data of the rear area of the vehicle.

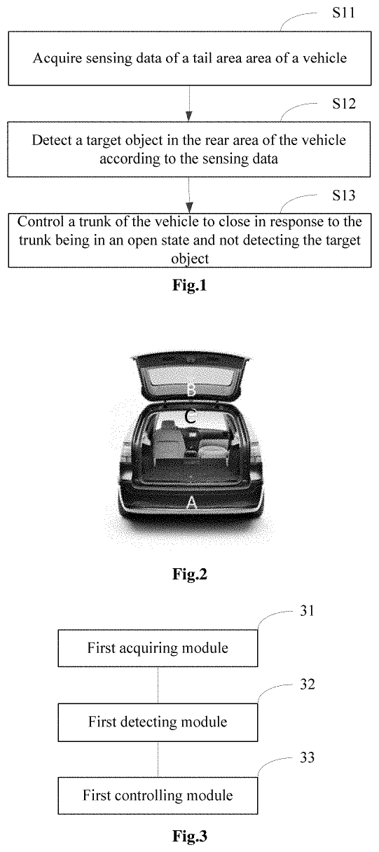

FIG. 2 is a schematic diagram of a position of a sensor in an embodiment of the present disclosure. The sensor may include a camera and a radar. The camera may include a reversing camera installed at the bottom end (position A) of the rear portion of the vehicle, a first camera installed on the inner side surface of the trunk (e.g., on a high-mounted brake light, position B as shown), and an OMS camera installed on the rear-view mirror (position C); and the radar may include a reversing radar installed in position A.

In a possible implementation, acquiring sensing data of a rear area of a vehicle includes: acquiring sensing data of a rear area of the vehicle in response to a duration of the trunk being in the open state reaching a second preset time length. For example, the second preset time length may be 1 minute. Of course, those skilled in the art may set the second preset time length according to the requirements of the actual application scenario, and the user may set and/or change the second preset time length according to the requirements of the actual application scenario and/or personal preference, which is not limited herein. By acquiring sensing data of a rear area of a vehicle in response to a duration of the trunk being in the open state reaching a second preset time length, it is possible to improve the efficiency and the accuracy of the trunk control and reduce trunk control operation that is unnecessary or not required by the user. For example, after the driver in the vehicle cabin controls the trunk to open, it may take a short time for the occupant who needs to pick up articles from the trunk to reach the rear area of the vehicle. In this implementation, by setting the second preset duration, it is possible to effectively cope with the situation that the occupant has not arrived at the rear area of the vehicle. Of course, in another possible implementation, the sensing data of the rear area of the vehicle may be acquired continuously, which is not limited here.

In a possible implementation, the method further includes: controlling the trunk to open in response to detecting a target object in the rear area of the vehicle according to the sensing data during a process of closing the trunk. In this implementation, during the process of closing the trunk, the target object in the rear area of the vehicle may continue to be detected according to the sensing data, and in response to detecting the target object, the process of closing the trunk may be interrupted and the trunk controlled to be opened, thereby improving the safety of the trunk control further and reducing the possibility of the user being injured due to being pinched by the trunk door.

In a possible implementation, the method further includes: resetting timing in response to detecting the target object; and detecting a target object in the rear area of the vehicle according to the sensing data includes: detecting the target object in the rear area of the vehicle according to the sensing data in response to a timing duration reaches a third preset time length. For example, the third preset time length may be 1 minute. Of course, those skilled in the art may set the third preset time length according to the requirements of the actual application scenario, which is not limited herein.

In a possible implementation, the method further includes: acquiring image data of a driving area of the vehicle collected by a Driver Monitoring System (DMS) camera; detecting whether a driver is seated in the driving area according to the image data of the driving area; sending inquiry information for asking whether to close the trunk in response to detecting that a driver is seated in the driving area and the trunk is in the open state; and controlling the trunk to close in response to receiving a closing request corresponding to the inquiry information. In this implementation, by asking the driver whether to close the trunk in response to detecting that the driver is seated in the driving area and the trunk is in the open state, and controlling the trunk to close after receiving a closing request of the driver for closing the trunk, it is possible to further improve the convenience of trunk control and strengthen property safety in the vehicle cabin (including the trunk).

In a possible implementation, the method further includes: determining a personnel object requesting opening the trunk as a target object in response to detecting that the trunk is changed from a closed state to the open state; and detecting a target object in the rear area of the vehicle according to the sensing data includes: detecting whether personnel objects in the rear area of the vehicle include the target object according to the sensing data. In this implementation, the user may request to open the trunk by voice, a button, a remote controller, or other means. For example, the personnel object requesting opening the trunk may be determined through voice print identification. For another example, the personnel object requesting opening the trunk may be determined by analyzing an image or a video stream inside and/or outside the vehicle cabin in response to detecting that a button for opening the trunk is triggered. For another example, all personnel objects in the vehicle cabin may be determined as the target object. In this implementation, by detecting whether personnel objects in the rear area of the vehicle include the personnel object requesting opening the trunk according to the sensing data, and controlling the trunk to close in response to the trunk of the vehicle being in the open state and not detecting the personnel object requesting opening the trunk, it is possible to close the trunk in time after the personnel object requesting opening the trunk leaves the rear area of the vehicle, thereby further strengthening the property safety in the vehicle cabin (including the trunk).

As an example of the implementation, the method further includes: controlling the trunk to open in response to the trunk being in the closed state and detecting that a preset personnel object requests opening the trunk according to the sensing data of the rear area of the vehicle. In the example, the preset personnel object may include a pre-registered personnel, for example, including a pre-registered driver and/or other occupants. In an example, it may be determined that a preset personnel object requesting opening the trunk in response to the trunk being in the closed state and detecting that the preset personnel object faces the trunk and a time of stay reaches a fourth preset time length according to the image data of the rear area of the vehicle. According to the example, it is possible to facilitate opening the trunk by the user based on the sensing data.

An application scenario of an embodiment of the present disclosure is described below. In the application scenario, after getting off the vehicle, the driver takes out the luggage from the trunk of the vehicle. The camera and/or the radar collects the sensing data of the rear area of the vehicle, and the controller detects the target object in the rear area of the vehicle according to the sensing data. After the driver leaves the rear area of the vehicle, the controller controls the trunk to close automatically in response to the trunk being in an open state and not detecting the target object.

It may be understood that the above method embodiments described in the present disclosure may be combined with each other to form combined embodiments without departing from principles and logics, which are not repeated in the present disclosure due to limited space. It will be appreciated by those skilled in the art that a specific execution sequence of various steps in the above method of specific implementations are determined by their functions and possible intrinsic logics.

Furthermore, the present disclosure further provides a trunk control apparatus, an electronic device, a computer-readable storage medium, and a program, all of which may be used to implement any trunk control method provided by the present disclosure. The corresponding technical solutions and technical effects may refer to the corresponding records in the method section, and will not be repeated herein.

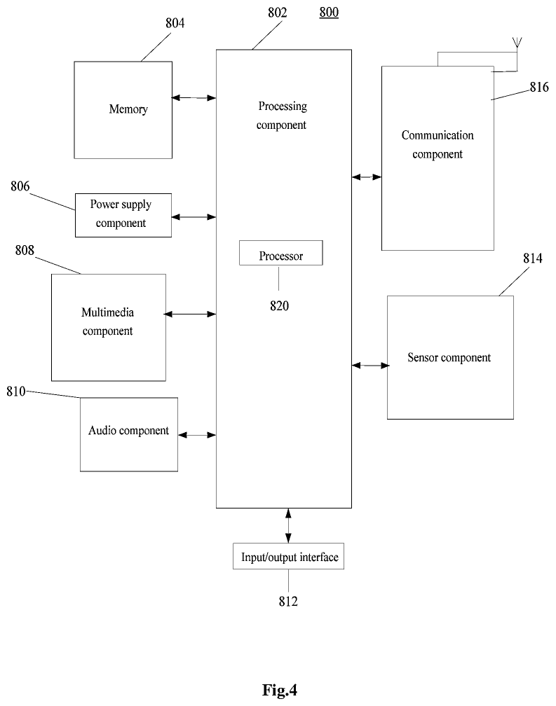

FIG. 3 is a block diagram of a trunk control apparatus provided in an embodiment of the present disclosure. As shown in FIG. 3, the trunk control apparatus includes a first acquiring module 31 configured to acquire sensing data of a rear area of a vehicle; a first detecting module 32 configured to detect a target object in the rear area of the vehicle according to the sensing data, and a first controlling module 33 configured to control a trunk to close in response to the trunk of the vehicle being in an open state and not detecting the target object.

In a possible implementation, the first detecting module 32 is configured to detect the target object within a preset distance range from the rear portion of the vehicle to the exterior of a vehicle cabin according to the sensing data; and the first controlling module 33 is configured to control the trunk to close in response to the trunk being in an open state and not detecting the target object within the preset distance range from the rear portion of the vehicle to the exterior of the vehicle cabin.

In a possible implementation, the first controlling module 33 is configured to control the trunk to close in response to the trunk being in an open state and not detecting the target object within a first preset time length.

In a possible implementation, the target object includes a human body object; the first detecting module 32 is configured to detect information of at least one human body part in the rear area of the vehicle according to the sensing data, determine that the human body object in the rear area of the vehicle is detected in response to the information of at least one human body part is detected in the rear area of the vehicle, and/or determine that the human body object in the rear area of the vehicle is not detected in response to the information of at least one human body part is not detected in the rear area of the vehicle.

In a possible implementation, the first acquiring module 31 is configured to acquire first image data of the rear area of the vehicle collected by a reversing camera; and the first detecting module 32 is configured to detect the information of at least one human body part in the rear area of the vehicle according to the first image data.

In a possible implementation, the first detecting module 32 is configured to detect foot information and/or leg information in the rear area of the vehicle according to the first image data in a case where the reversing camera faces the ground; and/or detect human body information and/or face information in the rear area of the vehicle according to the first image data in a case where the reversing camera faces a direction away from the ground.

In a possible implementation, the first acquiring module 31 is configured to acquire second image data of the rear area of the vehicle collected by a first camera, wherein the first camera is installed on an inner side surface of a trunk door; and the first detecting module 32 is configured to detect the information of at least one human body part in the rear area of the vehicle according to the second image data.

In a possible implementation, the first camera is installed in a position of a high-mounted brake light on the trunk door.

In a possible implementation, the apparatus further includes: a second controlling module configured to control the first camera to collect the second image data of the rear area of the vehicle in response to the trunk being opened.

In a possible implementation, the sensing data includes radar sensing data; the first detecting module 32 is configured to perform obstacle detection on the rear area of the vehicle according to the radar sensing data, determine that the information of at least one human body part in the rear area of the vehicle is detected in response to detecting presence of an obstacle in the rear area of the vehicle according to the radar sensing data, and/or determine that the information of at least one human body part in the rear area of the vehicle is not detected in response to in response to not detecting presence of an obstacle in the rear area of the vehicle according to the radar sensing data.

In a possible implementation, the first acquiring module 31 is configured to acquire the radar sensing data of the rear area of the vehicle collected by a reversing radar.

In a possible implementation, the first acquiring module 31 is configured to acquire third image data of the rear area of the vehicle collected by an Occupant Monitoring System (OMS) camera; and the first detecting module 32 is configured to detect human body information and/or face information in the rear area of the vehicle according to the third image data, and determine that the target object is detected in response to the human body information or face information is detected in the rear area of the vehicle.

In a possible implementation, the OMS camera is installed on an inner rear-view mirror of the vehicle and faces a rear direction of the vehicle.

In a possible implementation, the first acquiring module 31 is configured to acquire the sensing data of the rear area of the vehicle in response to a duration of the trunk being in the open state reaching a second preset time length.

In a possible implementation, the apparatus further includes: a fifth controlling module configured to control the trunk to open in response to detecting a target object in the rear area of the vehicle according to the sensing data during a process of closing the trunk.

In a possible implementation, the apparatus further includes: a second acquiring module configured to acquire image data of a driving area of the vehicle collected by a Driver Monitoring System (DMS) camera; a second detecting module configured to detect whether the driver is seated in the driving area according to the image data of the driving area; a sending module configured to send inquiry information for asking whether to close the trunk in response to detecting that the driver is seated in the driving area and the trunk is in the open state; and a third controlling module configured to control the trunk to close in response to receiving a closing request corresponding to the inquiry information.

In a possible implementation, the apparatus further includes: a determining module configured to determine a personnel object requesting opening the trunk as the target object in response to detecting that the trunk is changed from a closed state to the open state; and the first detecting module 32 is configured to detect whether personnel objects in the rear area of the vehicle include the target object according to the sensing data.

In a possible implementation, the apparatus further includes: a fourth controlling module configured to control the trunk to open in response to the trunk being in the closed state and detecting that the preset personnel object requests opening the trunk according to the sensing data of the rear area of the vehicle.

In an embodiment of the present disclosure, by acquiring sensing data of the rear area of the vehicle, detecting a target object in the rear area of the vehicle according to the sensing data, and controlling a trunk of the vehicle to close in response to the trunk being in an open state and not detecting the target object, it is possible to realize automated closing of the trunk based on the sensing data of the rear area of the vehicle and non-contact closing of the trunk; that is, the trunk closes automatically without the user touching the trunk door, thereby improving the convenience for closing the trunk. Furthermore, by controlling a trunk of the vehicle to close in response to the trunk being in an open state and not detecting the target object, it is possible to greatly reduce the possibility of the user being injured due to being pinched by the trunk door, improving the safety in trunk control. Moreover, by automated closing of the trunk door according to the embodiment of the present disclosure is also conducive to strengthening property safety of the vehicle cabin (including the trunk).

An embodiment of the present disclosure further provides a vehicle, comprising a sensor configured to collect sensing data of a rear area of a vehicle; a controller configured to acquire the sensing data from the sensor, detect a target object in the rear area of the vehicle according to the sensing data, and control a trunk to close in response to the trunk of the vehicle being in an open state and not detecting the target object.

In a possible implementation, the sensor includes a radar and/or a camera. The camera includes at least one of a reversing camera, a first camera, and an OMS camera. The first camera is installed on an inner side surface of the trunk door close to a roof.

In some embodiments, functions or modules of the apparatus and the vehicle provided in the embodiments of the present disclosure may be used to execute the method described in the above method embodiments, the specific implementation and technical effect of which may refer to the above descriptions of the method embodiments, and are not repeated here for brevity.

An embodiment of the present disclosure further provides a computer readable storage medium having computer program instructions stored thereon, wherein the computer program instructions implement the above method when executed by a processor. The computer readable storage medium may be a non-volatile computer readable storage medium or a volatile computer readable storage medium.

An embodiment of the present disclosure further provides a computer program product including computer readable codes. When the computer readable codes are run on an electronic device, the processor in the electronic device executes the above method.

An embodiment of the present disclosure further provides another computer program product configured to store computer readable instructions. The instructions are executed to cause the computer to perform operation of the trunk control method provided in any one of the above embodiments.

An embodiment of the present disclosure further provides an electronic device comprising one or more processors, and a memory configured to store executable instructions, wherein the one or more processors are configured to call the executable instructions stored in the memory to execute the above method.

The electronic device may be provided as a terminal, a server, or a device in any other form. The electronic device may be a controller, a domain controller, or a vehicle machine in a vehicle cabin, and or a device host for processing images and other data in an OMS or a DMS.

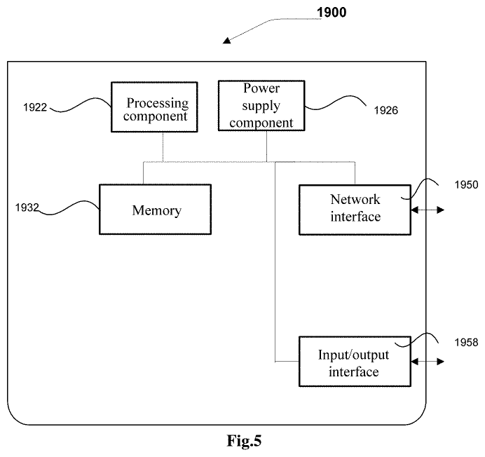

FIG. 4 is a block diagram of an electronic device 800 provided in an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 4, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to the power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative positions of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a complementary metal oxide semiconductor (CMOS) or charge coupled device (CCD) image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as wireless fidelity (Wi-Fi), second generation mobile communication technology (2G), third generation mobile communication technology (3G), fourth generation mobile communication (4G) technology/long-term evolution of universal mobile communication technology (LTE), fifth generation mobile communication technology (5G) or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultrawide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

FIG. 5 is a block diagram of an electronic device 1900 provided in an embodiment of the present disclosure. For example, the electronic device 1900 may be provided as a server. Referring to FIG. 5, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as windows server operating system (Windows Server™, graphical user interface operating system (Mac OS X™) introduced by Apple, a multi-user and multi-process computer operating system (Unix™), Unix-like operating system with free and open source codes (Linux™), open source Unix-like operating system (FreeBSD™) or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing devices from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operation of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flow chart and/or the block diagrams of the method, device (systems), and computer program product according to the embodiments of the present disclosure. It will be appreciated that each block in the flow chart and/or the block diagram, and combinations of blocks in the flow chart and/or block diagram, may be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flow chart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flow chart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flow chart and/or block diagram.

The flow charts and block diagrams in the drawings illustrate the architecture, function, and operation that may be implemented by the system, method and computer program product according to the various embodiments of the present disclosure. In this regard, each block in the flow chart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flow chart, and combinations of blocks in the block diagram and/or flow chart, may be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A trunk control method, comprising:
acquiring sensing data of a rear area of a vehicle;
detecting a target object in the rear area of the vehicle based on the sensing data; and
controlling a trunk of the vehicle to close in response to the trunk being in an open state and not detecting the target object.

2. The method according to claim 1, wherein
detecting the target object in the rear area of the vehicle based on the sensing data comprises: detecting the target object within a preset distance range from a rear portion of the vehicle to an exterior of a vehicle cabin based on the sensing data; and
controlling the trunk of the vehicle to close in response to the trunk being in the open state and not detecting the target object comprises: controlling the trunk to close in response to the trunk being in the open state and not detecting the target object within the preset distance range from the rear portion of the vehicle to the exterior of the vehicle cabin.

3. The method according to claim 1, wherein controlling the trunk of the vehicle to close in response to the trunk being in the open state and not detecting the target object comprises:
controlling the trunk to close in response to the trunk being in the open state and not detecting the target object within a first preset time length.

4. The method according to claim 1, wherein the target object comprises a human body object;
detecting the target object in the rear area of the vehicle based on the sensing data comprises:
detecting information of at least one human body part in the rear area of the vehicle based on the sensing data; and
determining that a human body object in the rear area of the vehicle is detected in response to the information of at least one human body part is detected in the rear area of the vehicle; and/or determining that the human body object in the rear area of the vehicle is not detected in response to the information of at least one human body part is not detected in the rear area of the vehicle.

5. The method according to claim 4, wherein
acquiring the sensing data of the rear area of the vehicle comprises: acquiring first image data of the rear area of the vehicle collected by a reversing camera; and
detecting the information of at least one human body part in the rear area of the vehicle based on the sensing data comprises: detecting the information of at least one human body part in the rear area of the vehicle based on the first image data.

6. The method according to claim 5, wherein detecting the information of at least one human body part in the rear area of the vehicle based on the sensing data comprises:
detecting foot information and/or leg information in the rear area of the vehicle based on the first image data in a case where the reversing camera faces the ground;
and/or,
detecting human body information and/or face information in the rear area of the vehicle based on the first image data in a case where the reversing camera faces a direction away from the ground.

7. The method according to claim 4, wherein
acquiring the sensing data of the rear area of the vehicle comprises: acquiring second image data of the rear area of the vehicle collected by a first camera, wherein the first camera is installed on an inner side surface of a trunk door; and
detecting the information of at least one human body part in the rear area of the vehicle based on the sensing data comprises: detecting the information of at least one human body part in the rear area of the vehicle based on the second image data.

8. The method according to claim 7, wherein the first camera is installed in a position of a high-mounted brake light on the trunk door.

9. The method according to claim 7, wherein the method further comprises:
controlling the first camera to collect the second image data of the rear area of the vehicle in response to the trunk being opened.

10. The method according to claim 4, wherein the sensing data comprises radar sensing data;
detecting the information of at least one human body part in the rear area of the vehicle based on the sensing data comprises:
performing obstacle detection on the rear area of the vehicle based on the radar sensing data; and
determining that the information of at least one human body part in the rear area of the vehicle is detected in response to detecting presence of an obstacle in the rear area of the vehicle based on the radar sensing data; and/or determining that the information of at least one human body part in the rear area of the vehicle is not detected in response to not detecting presence of an obstacle in the rear area of the vehicle based on the radar sensing data.

11. The method according to claim 10, wherein acquiring the sensing data of the rear area of the vehicle comprises:
acquiring radar sensing data of the rear area of the vehicle collected by a reversing radar.

12. The method according to claim 1, wherein
acquiring the sensing data of the rear area of the vehicle comprises: acquiring third image data of the rear area of the vehicle collected by an Occupant Monitoring System (OMS) camera; and
detecting the target object in the rear area of the vehicle based on the sensing data comprises: detecting human body information and/or face information in the rear area of the vehicle based on the third image data; and determining that the target object is detected in response to the human body information or the face information is detected in the rear area of the vehicle.

13. The method according to claim 12, wherein the OMS camera is installed on an inner rear-view mirror of the vehicle and faces a rear direction of the vehicle.

14. The method according to claim 1, wherein acquiring the sensing data of the rear area of the vehicle comprises:
acquiring the sensing data of the rear area of the vehicle in response to a duration of the trunk being in the open state reaching a second preset time length.

15. The method according to claim 1, wherein the method further comprises:
controlling the trunk to open in response to detecting the target object in the rear area of the vehicle based on the sensing data during a process of closing the trunk.

16. The method according to claim 1, wherein the method further comprises:
acquiring image data of a driving area of the vehicle collected by a Driver Monitoring System (DMS) camera;
detecting whether a driver is seated in the driving area based on the image data of the driving area;
sending inquiry information for asking whether to close the trunk in response to detecting that the driver is seated in the driving area and the trunk is in the open state; and
controlling the trunk to close in response to receiving a closing request corresponding to the inquiry information.

17. The method according to claim 1, wherein the method further comprises:
determining a personnel object requesting opening the trunk as a target object in response to detecting that the trunk is changed from a closed state to the open state; and
detecting the target object in the rear area of the vehicle based on the sensing data comprises:
detecting whether the personnel object in the rear area of the vehicle comprises the target object based on the sensing data.

18. The method according to claim 17, wherein the method further comprises:
controlling the trunk to open in response to the trunk being in the closed state and detecting that a preset personnel object requests opening the trunk based on the sensing data of the rear area of the vehicle.

19. A trunk control apparatus, comprising:
a processor; and
a memory configured to store processor-executable instructions,
wherein the processor is configured to invoke the instructions stored in the memory, so as to:
acquire sensing data of a rear area of a vehicle;
detect a target object in the rear area of the vehicle based on the sensing data; and
control a trunk to close in response to the trunk of the vehicle being in an open state and not detecting the target object.

20. A non-transitory computer readable storage medium having computer program instructions stored thereon, wherein the computer program instructions, when executed by at least one processor, implement a method of:
acquiring sensing data of a rear area of a vehicle;
detecting a target object in the rear area of the vehicle based on the sensing data; and
controlling a trunk of the vehicle to close in response to the trunk being in an open state and not detecting the target object.
